(19) United States
(12) Patent Application Publication
(10) Pub. No.: US 2009/0268342 A1
(43) Pub. Date: Oct. 29, 2009

(54) DISK CLAMP AND HARD DISK DRIVE HAVING THE SAME

(75) Inventors: Woo Chul KIM, Suwon-si (KR); Woo Sung Kim, Seoul (KR); Shi-Jung Kim, Seoul (KR); Yoou Gyu Kam, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/428,534

(22) Filed: Apr. 23, 2009

(30) Foreign Application Priority Data
Apr. 23, 2008 (KR) 2008-037926

(51) Int. Cl. G11B 17/022

(52) U.S. Cl. 360/99.12

(57) ABSTRACT

A disk clamp to fix a disk to a hub of a spindle motor in a hard disk drive, and a hard disk drive having the disk clamp. The disk clamp can include a coupling hole formed at a center of the disk clamp, in which a clamping screw is inserted, at least one through hole formed outside the coupling hole, and a pressing portion provided at an outer circumferential side of the disk clamp to contact and press the disk. A particular area around the at least one through hole that is away from the at least one through hole can have a sectional thickness thinner than a predetermined area that is adjacent to the at least one through hole, to prevent stress distribution generated at a contact surface between the pressing portion and the disk from being irregular due to the at least one through hole.

### CROSS-REFERENCE TO RELATED APPLICATIONS

This application claims priority under 35 U.S.C. §119 to Korean Patent Application No. 10-2008-0037926, filed on Apr. 23, 2008 in the Korean Intellectual Property Office, the disclosure of which is incorporated herein by reference in its entirety.

### BACKGROUND

1. Field of the Inventive Concept

The present general inventive concept relates to a disk clamp and a hard disk drive (HDD) having the disk clamp, and more particularly, to a disk clamp to improve stress distribution characteristics and uniformity at a contact surface between the disk clamp and a disk, and an HDD having the disk clamp.

2. Description of the Related Art

HDDs are data storage devices capable of recording data on a disk or reproducing data stored on the disk, by changing digital electronic pulses including data information to a permanent magnetic field. The HDDs are widely used as auxiliary memory devices of computer systems because of their fast access time to a large amount of data for recording or reproduction.

As HDDs having a high TPI (tracks per inch) and a high BPI (bits per inch) have been developed, an increase in the data storage capacity and a decrease in the size of HDDs have been rapidly realized. Also, the application of the HDD has been expanded to laptops, MP3 players, mobile communication terminals, etc.

In general, an HDD includes at least one disk for recording data, a spindle motor for rotating the disk, a head stack assembly (HSA) for recording and reproducing data with respect to the disk while pivoting around a pivot shaft across the disk, a printed circuit board assembly (PCBA) having a printed circuit board (PCB), on which most circuit parts are installed, and electrically controlling the HDD, a base on which the above constituent elements are assembled, and a cover covering the base.

The HDD includes a clamp, as one of the constituent elements, to fix the disk to a hub of a spindle motor. FIG. 1 is a perspective view of a conventional clamp. FIG. 2 is a partially cut-away perspective view taken along line II-II, illustrating the clamp of FIG. 1.

Referring to FIGS. 1 and 2, the conventional disk clamp 130 includes a coupling hole 132 formed at the center of the disk clamp 130, in which a clamping screw (not illustrated) is inserted, four through holes 135 circumferentially arranged outside of the coupling hole 132 in the same interval, a pressing portion 133 provided at the outer edge of the disk clamp 130 to contact and press the upper surface of the disk, and an accommodation unit 131 supporting a head portion (not illustrated) of the clamping screw. The four through holes 135 formed in the disk clamp 130 function as guide holes in the assembling of the disk clamp 130 on the spindle motor.

However, the through holes 135 circumferentially formed in the disk clamp 130 causes irregular distribution of stress that is generated in a contact surface between the disk clamp 130 and the disk. This is because the strength of the disk clamp 130 varies in the circumferential direction due to the through holes 135 that are circumferentially formed in the disk clamp 130. Since the strength of the disk clamp 130 is relatively weak in an area adjacent to the through holes 135 due to the through holes 135, a stress concentration phenomenon is generated by a clamping force.

The stress concentration phenomenon generated in the area adjacent to the through holes 135 makes the stress distribution in the circumferential direction of the contact surface of the disk contacting the disk clamp 130 irregular. As a result, the smoothness of the disk is deteriorated due to a disk warpage. The deteriorated smoothness of a disk due to the irregular stress distribution increases repeatable run out (RRO) during the rotation of the disk so that the recording and reproduction performance of an HDD may be deteriorated.

### SUMMARY

The present general inventive concept provides a disk clamp which can improve a stress distribution characteristic and uniformity at a contact surface between the disk clamp and a disk, and an HDD having the disk clamp.

Additional embodiments of the present general inventive concept will be set forth in part in the description which follows and, in part, will be obvious from the description, or may be learned by practice of the general inventive concept.

An example embodiment of the present general inventive concept provides a disk clamp to fix a disk to a hub of a spindle motor in a hard disk drive, including a coupling hole formed at a center of the disk clamp, in which a clamping screw can be inserted, at least one through hole formed outside the coupling hole, and a pressing portion provided at an outer circumferential side of the disk clamp to contact and press the disk, wherein a particular area around the at least one through hole that is away from the at least one through hole has a sectional thickness thinner than a predetermined area that is adjacent to the at least one through hole, to prevent stress distribution generated at a contact surface between the pressing portion and the disk from being irregular due to the at least one through hole.

The at least one through hole may include a plurality of through holes formed outside the coupling hole in a circumferential direction, and the particular area may be obtained by deducting the predetermined area that is adjacent to each of the plurality of through holes from a first zone that is an area between the pressing portion and an imaginary closed curve connecting the centers of the plurality of through holes.

A second zone that is an area between the imaginary closed curve and the coupling hole may have substantially the same sectional thickness as the predetermined area that is adjacent to each of the plurality of through holes.

The particular area may be stamping processed to have a sectional thickness thinner than the predetermined area that is adjacent to the through hole.

The predetermined area that is adjacent to each of the plurality of through holes may have a substantially triangular shape.

The predetermined area that is adjacent to each of the plurality of through holes may be defined by the imaginary closed curve and two straight lines forming a substantially triangular shape.

The two straight lines may be symmetrical to an imaginary line connecting the center of the coupling hole and the center of the through hole and respectively inclined by an angle within a range of 10°-20° with respect to the imaginary line.

The predetermined area that is adjacent to each of the plurality of through holes may have a substantially oval or polygonal shape.

The particular area may be processed to have a sectional thickness difference in a range of 0.1 mm to 0.15 mm, compared to the predetermined area that is adjacent to the through hole.

The plurality of through holes may be guide holes to align the disk clamp on the hub of the spindle motor, and may be four through holes formed in the disk clamp in the same interval in the circumferential direction.

The plurality of through holes may be formed on a single circle to allow the imaginary closed curve to form a circle.

The disk clamp may further include an accommodation portion to support a head portion of the clamping screw, and a horizontal portion extending toward the pressing portion and to maintain a predetermined height after being bent upwardly from the accommodation portion.

The disk clamp may further include an inclined portion to connect the horizontal portion and the pressing portion by being inclined downwardly with respect to the horizontal portion.

Exemplary embodiments of the present inventive concept also provide a hard disk drive including a disk on which data is recorded or reproduced, a spindle motor to rotate the disk, a disk clamp to fix the disk to a hub of the spindle motor, wherein the disk clamp can include a coupling hole formed at a center of the disk clamp, in which a clamping screw is inserted, at least one through hole formed outside the coupling hole, and a pressing portion provided at an outer circumferential side of the disk clamp to contact and press the disk, wherein a particular area around the at least one through hole that is away from the at least one through hole has a sectional thickness thinner than a predetermined area that is adjacent to the at least one through hole, to prevent stress distribution generated at a contact surface between the pressing portion and the disk from being irregular due to the at least one through hole.

The at least one through hole may be a plurality of through holes formed outside the coupling hole in a circumferential direction, and the particular area may be obtained by deducting the predetermined area that is adjacent to each of the plurality of through holes from a first zone that is an area between the pressing portion and an imaginary closed curve connecting the centers of the plurality of through holes.

A second zone that is an area between the imaginary closed curve and the coupling hole may have substantially the same sectional thickness as the predetermined area that is adjacent to each of the plurality of through holes.

The particular area may be stamping processed to have a sectional thickness thinner than the predetermined area that is adjacent to the through hole.

The predetermined area that is adjacent to each of the plurality of through holes may have a substantially triangular shape.

The predetermined area that is adjacent to each of the plurality of through holes may be defined by the imaginary closed curve and two straight lines forming a substantially triangular shape.

The two straight lines may be symmetrical to an imaginary line connecting the center of the coupling hole and the center of the through holes and respectively inclined by an angle within a range of 10°-20° with respect to the imaginary line.

The hard disk drive may further include an accommodation portion to support a head portion of the clamping screw, and a horizontal portion extending toward the pressing portion and to maintain a predetermined height after being bent upwardly from the accommodation portion.

The hard disk drive may further include an inclined portion to connect the horizontal portion and the pressing portion by being inclined downwardly with respect to the horizontal portion.

Exemplary embodiments of the present general inventive concept also provide a disk clamp to fasten a disk to a hub of a disk drive, the disk clamp including a coupling hole formed at a center of the disk clamp to receive the hub, at least one through hole formed between an outer circumferential side of the disk clamp and the coupling hole, and a pressing portion formed at the outer circumferential side of the disk clamp to contact a surface of the disk such that a thickness of a first sectional area of the disk clamp adjacent to the at least one through hole is greater than a thickness of a second sectional area of the disk clamp spaced apart from the at least one through hole.

The at least one through hole may include a plurality of through holes circumferentially arranged about the center of the disk clamp.

The first sectional area may include a first area disposed between an imaginary curve connecting the centers of the plurality of through holes and an outer edge of the coupling hole, and a second area disposed between lines extending from the imaginary curve to the pressing portion on opposite sides of the plurality of through holes, respectively.

The first sectional area may include a triangular portion enclosing the at least one through hole, the triangular portion having a vertex disposed proximate the pressing portion and sides extending therefrom on opposite sides of the at least one through hole to define a boundary between the first sectional area and the second sectional area.

The sides of the triangular shape can be symmetrical to an imaginary line connecting the center of the coupling hole and the center of each of the at least one through holes.

The first sectional area may include a rectangular portion enclosing the at least one through hole, the rectangular portion having sides extending from opposite sides of the at least one through hole toward the pressing portion to define a boundary between the first sectional area and the second sectional area.

Exemplary embodiments of the present general inventive concept also provides a hard disk drive including a disk clamp to fasten a disk to a hub of the hard disk drive, the disk clamp including a coupling hole formed at a center of the disk clamp to receive the hub, at least one through hole formed between an outer circumferential side of the disk clamp and the coupling hole, and a pressing portion formed at the outer circumferential side of the disk clamp to contact a surface of the disk such that a thickness of a first sectional area of the disk clamp adjacent to the at least one through hole is greater than a thickness of a second sectional area of the disk clamp spaced apart from the at least one through hole.

### BRIEF DESCRIPTION OF THE DRAWINGS

Exemplary embodiments of the present general inventive concept will be more clearly understood from the following detailed description taken in conjunction with the accompanying drawings in which:

FIG. 1 is a perspective view of the conventional clamp;

FIG. 2 is a partially cut-away perspective view taken along line II-II, illustrating the clamp of FIG. 1;

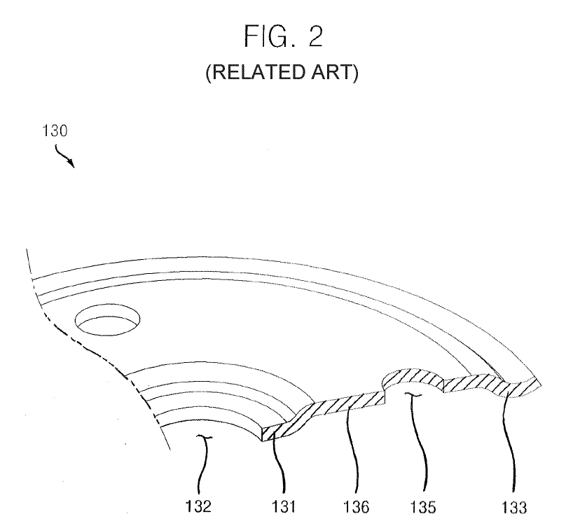

FIG. 3 is a perspective view of an HDD according to an exemplary embodiment of the present general inventive concept;

FIG. 4 is an exploded perspective view of the HDD of FIG. 3;

FIG. 5 is a cross-sectional view taken along line V-V of FIG. 3;

FIG. 6 is a perspective view of a disk clamp according to an exemplary embodiment of the present general inventive concept;

FIG. 7 is a plan view of the disk clamp of FIG. 6;

FIG. 8 is a cross-sectional view taken along line VIII-VIII of FIG. 6;

FIG. 9A is a cross-sectional view of the disk clamp taken along line VIII-VIII of FIG. 6;

FIG. 9B is a cross-sectional view of the conventional disk clamp taken along line II-II of FIG. 1;

FIG. 10 is a graph illustrating a result of comparison in the circumferential disk displacement distribution generated between the conventional disk clamp of FIG. 1 and the disk clamp of FIG. 6;

FIG. 11 is a plan view of a disk clamp according to another exemplary embodiment of the present general inventive concept; and

FIG. 12 is a plan view of a disk clamp according to another exemplary embodiment of the present general inventive concept.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

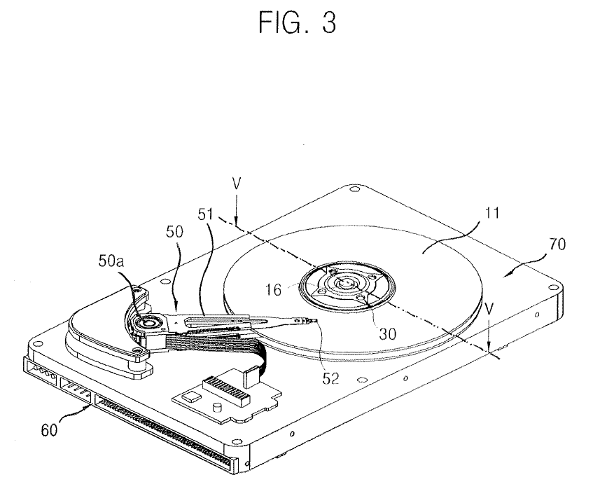

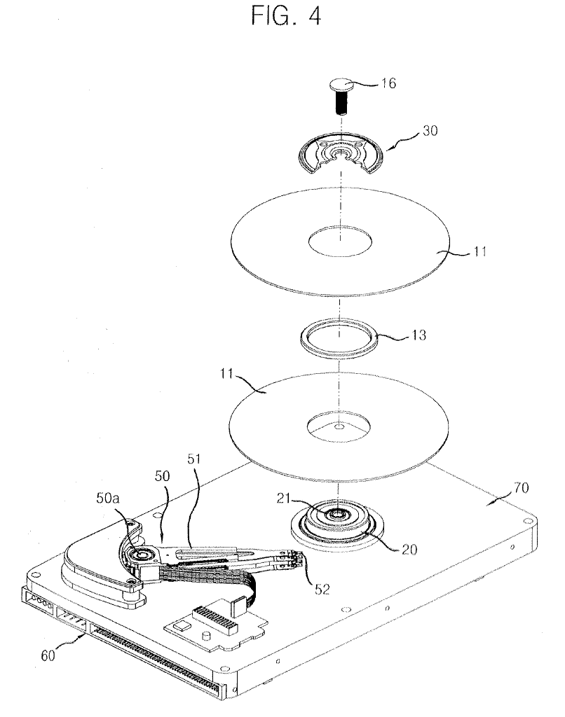

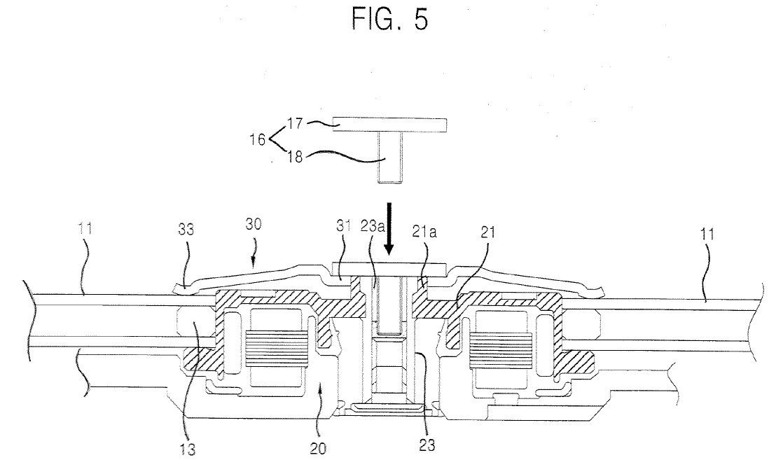

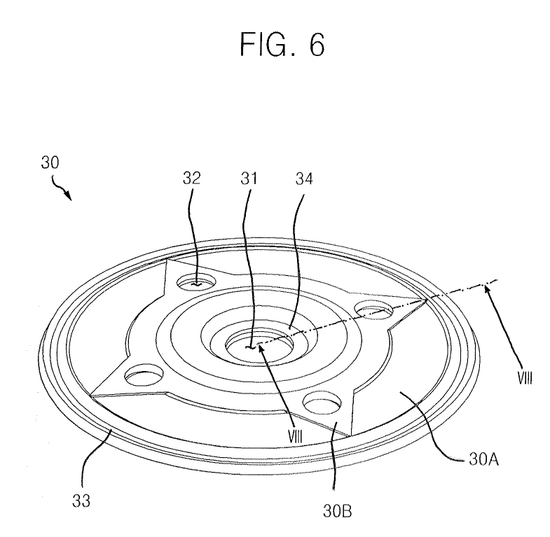

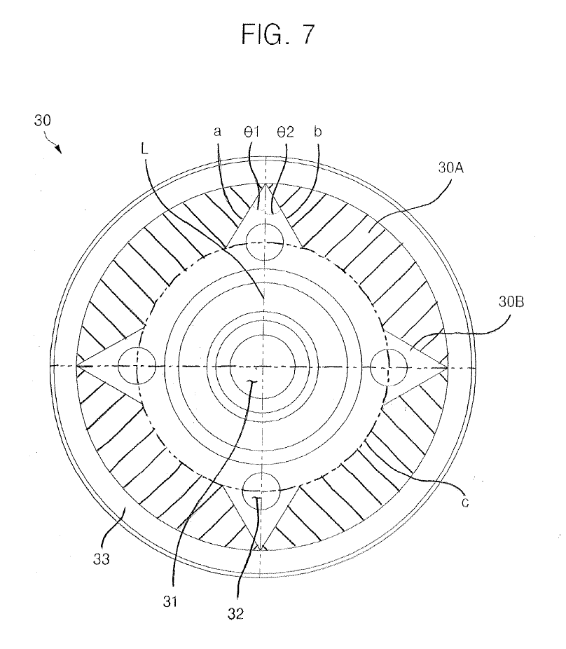

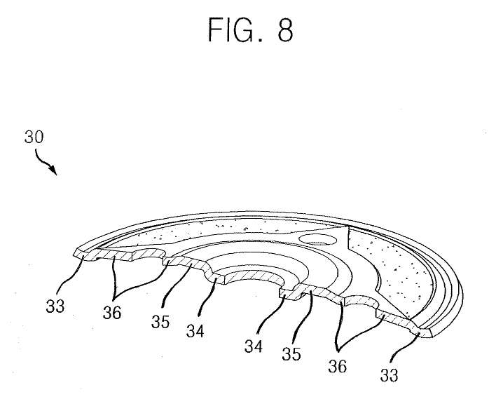

FIG. 3 is a perspective view of an HDD according to an exemplary embodiment of the present general inventive concept. FIG. 4 is an exploded perspective view of the HDD of FIG. 3. FIG. 5 is a cross-sectional view taken along line V-V of FIG. 3. FIG. 6 is a perspective view of a disk clamp according to an exemplary embodiment of the present inventive concept. FIG. 7 is a plan view of the disk clamp of FIG. 6. FIG. 8 is a cross-sectional view taken along line VIII-VIII of FIG. 6.

Referring to FIGS. 3-5, an HDD according to an example embodiment can include at least one disk 11 to record data, a spindle motor 20 to rotate the disk 11, a head stack assembly (HSA) 50 to record and reproduce data with respect to the disk 11 while pivoting around a pivot shaft 50a across the disk 11, a printed circuit board assembly (PCBA) 60 having a printed circuit board (PCB) on which most circuit parts are installed in order to electrically control the HDD, a base 70 on which the above constituent parts are assembled, and a cover (not illustrated) to cover the base 70.

The HSA 50 can include an actuator 51 to pivot around the pivot shaft 50a across the disk 11, and a magnetic head 52 provided at an end portion of the actuator 51. The magnetic head 52 can include a write head and a read head. When a read/write operation begins and the disk 11 starts to rotate, the actuator 51 can move the magnetic head 52 to a predetermined position on the disk 11 that is rotating so that the read/write operation may be performed.

Although a single disk may be used as the disk 11, a plurality of disks can also be used to record and reproduce a large amount of data. In the example embodiment of FIGS. 3-5, two disks are vertically deposited on the spindle motor 20, although more or less disks may also be used without departing from the broader principles and spirit of the present general inventive concept.

The spindle motor 20 can be installed on the base 70 and can include a shaft 23 to form a rotation shaft of the disk 11 and a hub 21 provided radially outside the shaft 23 to support the disk 11. As mentioned above, the example embodiment illustrated in FIGS. 3-5 can include two disks inserted on the hub 21 of the spindle motor 20, although more or less disks can also be used. The two disks can be separated a predetermined distance from each other by a spacer 13 having a ring shape, although other types and shapes of spacers could also be used. In this case, the two disks can be rotatably supported by the hub 21 of the spindle motor 20. A boss 21a can be provided to protrude a predetermined length from the surface of the hub 21 at the center of the hub 21 of the spindle motor 20.

The HDD according to an example embodiment can further include a disk clamp 30 to fix the disk 11 to the hub 21 of the spindle motor 20 and a clamping screw 16 to fix the disk 11 to the hub 21 of the spindle motor 20 by pressing the disk clamp 30.

Referring to FIGS. 6-8, the disk clamp 30 can include a coupling hole 31 formed at the center of the disk clamp 30, in which the boss 21a of the hub 21 can be inserted, a plurality of through holes 32 (four through holes in the present embodiment) circumferentially formed outside the coupling hole 31 in the same interval, a pressing portion 33 provided at the outer edge portion of the disk clamp 30 to contact and press the upper surface of the disk 11, and an accommodation portion 34 to support a head portion 17 of the clamping screw 16. The section of the pressing portion 33 can have a downwardly bulged shape as illustrated in FIG. 8.

The disk clamp 30 can be formed of a metal material such as an aluminum alloy or stainless steel (SUS) although other materials could also be used. Although the disk clamp 30 may be manufactured by a mechanical process such as cutting, a pressing process such as a process of making products in various shapes by plastic deforming a metal plate can be employed considering the manufacturing costs.

The clamping screw 16 can include the head portion 17 to press the accommodation portion 34 of the disk clamp 30 and a shaft portion 18 connected to the head portion 17 and inserted in a screw insertion portion 23a formed in the shaft 23 of the spindle motor 20 in the axial direction. The shaft portion 18 of the clamping screw 16 can be inserted through the coupling hole 31 of the disk clamp 30 and screw coupled to the screw insertion portion 23a of the shaft 23. The clamping screw 16 can provide a clamping force or clamping torque to fix the disk 11 to the hub 21 of the spindle motor 20. As the edge of the head portion 17 presses the accommodation portion 34 of the disk clamp 30, the pressing portion 33 of the disk clamp 30 can press the upper surface of the disk 11 to fix the disk 11 to the hub 21 of the spindle motor 20.

In the example embodiment, the four through holes 32 can be circumferentially formed in the disk clamp 30 in the same interval. The four through holes 32, which function as a sort of guide holes, can arrange or align the disk clamp 30 on the hub 21 of the spindle motor 20.

That is, in the process of assembling the disk clamp 30 on the hub 21 of the spindle motor 20, and before coupling the clamping screw 16, a process of arranging or aligning the disk clamp 30 at a predetermined position on the hub 21 of the spindle motor 20 using a transfer robot (not illustrated) can be performed. In the process, the transfer robot can grip the four through holes 32 to move the disk clamp 30 to the spindle motor 20 to arrange or align the disk clamp 30 on the hub 21 of the spindle motor 20. That is, the transfer robot can use the four through holes 32 of the disk clamp 30 to grip the disk clamp 30 to move or align the disk clamp 30. However, the present general inventive concept is not limited thereto. It is possible that only one through hole or five or more through holes may be formed in the disk clamp 30. Also, the function of the four through holes 32 is not limited to the function of arranging or aligning the disk clamp 30 on the hub 21 of the spindle motor 20.

However, although the four through holes 32 circumferentially formed in the disk clamp 30 can improve accuracy and convenience of the process of assembling the disk clamp 30 on the hub 21 of the spindle motor 20, as described in the background section of the present specification, the four through holes 32 may generate the irregular stress distribution in the circumferential direction at the contact surface between the disk clamp 30 and the disk 11.

To address the above problem, in the disk clamp 30 according to the present general inventive concept, a particular area 30A, or a hatched area in FIG. 7, around the four through holes 32, which is relatively far away from each of the four through holes 32, can be processed to have a thickness thinner than that of a predetermined area 30B that is relatively adjacent to each of the four through holes 32.

Such shape of the disk clamp 30, although not reinforcing the relatively weak strength of the predetermined area 30B adjacent to each of the four through holes 32, can reduce the strength of the particular area 30A around the four through holes 32, thereby making the overall strength substantially similar or uniform. Thus, the stress concentration phenomenon may be restricted.

In general, a disk clamp having a superior performance can fix the disk clamp 30 to the hub 21 of the spindle motor 20 by a clamping force sufficient to make the stress distribution generated at the contact surface between the disk 11 and the disk clamp 30 constant and to prevent a phenomenon having the disk pushed away when the disk 11 rotates at high speeds. For reference, the clamping force can be proportional to the overall strength of the disk clamp 30.

In the present general inventive concept, although various shapes of the surface of the particular area 30A and various thicknesses of the section of the particular area 30A may be selected, it is possible to appropriately select the shape of the surface and the sectional thickness of the particular area 30A that can provide a uniform stress distribution at the contact surface between the disk clamp 30 and the disk 11 while minimizing the decrease in the overall strength of the disk clamp 30.

For example, the shape of the surface and the sectional thickness of the particular area 30A of the disk clamp 30 according to an example embodiment described below are based on a result obtained through a variety of contact analysis simulation tests.

Referring to FIGS. 6-8, in the disk clamp 30 according to an example embodiment, assuming that an area between an imaginary closed curve c, as illustrated by a two-point chain line in FIG. 7, connecting the centers of the four through holes 32, and the pressing portion 33, is referred to as a first zone and an area between the imaginary closed curve c and the coupling hole 31 is referred to as a second zone, the particular area 30A around the four through holes 32, which is disposed away from each of the four through holes 32, signifies a part of the first zone, except for the predetermined area 30B that is adjacent to each of the four through holes 32. That is, the particular area 30A is the area obtained by deducting the predetermined area 30B from the first zone. The second zone has substantially the same sectional thickness as the predetermined area 30B.

In the example embodiment of FIGS. 6-8, the imaginary closed curve c can form a circle because the four through holes 32 are disposed on a single circle. The particular area 30A can be formed by any method that performs the intended purpose described herein to produce a difference in the sectional thickness in a range of about 0.1 mm to 0.15 mm compared to the predetermined area 30B that is adjacent to each of the fourth through holes 32. For example, a stamping process may be used to form the sectional thicknesses of the predetermined areas 30A and 30B.

Although the particular area 30A may also be obtained by a mechanical processing method such as cutting, a stamping processing method may be economical in terms of manufacturing costs. For example, a stamping processing, or die forging, can be used to form an uneven surface by applying a shock to a material inserted between upper and lower molds having uneven surfaces. Here, when the sectional thickness of the particular area 30A is made thin by the stamping processing, the particular area 30A can have substantially the same shape as a stamping shape.

As illustrated in FIGS. 6-8, the surface of the predetermined area 30B adjacent to each of the four through holes 32 can have a substantially triangular shape. Although it is possible that the surface of the predetermined area 30B may have a variety of shapes, results obtained through contact analysis simulation on a variety of shapes may indicate that a disk clamp having superior performance may be achieved by providing a predetermined area 30B having a substantially triangular shape as illustrated in FIG. 7.

For example, referring to FIG. 7, the predetermined area 30B can be defined by two straight lines a and b and the imaginary closed curve c, forming a substantially triangular shape. The two straight lines a and b can be symmetrical to an imaginary straight line L that connects the center of the coupling hole 31 and the center of each of the four through holes 32 and inclined at an angle θ1 and θ2 in a range of 10°-20° with respect to the imaginary line L.

Since the disk clamp 30 according to example embodiments of the present general inventive concept can be processed such that the particular area 30A around the four through hole 32 that is disposed away from each of the four through holes 32 may have a sectional thickness thinner than that of the predetermined area 30B that is adjacent to each of the four through holes, the decrease in the overall strength of the disk clamp 30 may be minimized, and simultaneously, the uniformity of the stress distribution at the contact surface between the disk clamp 30 and the disk 11 may be improved.

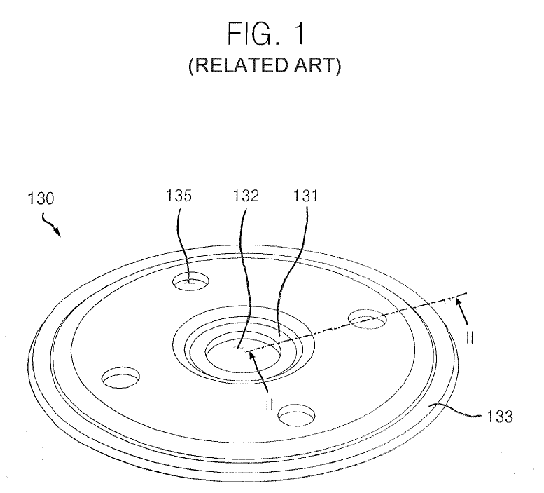

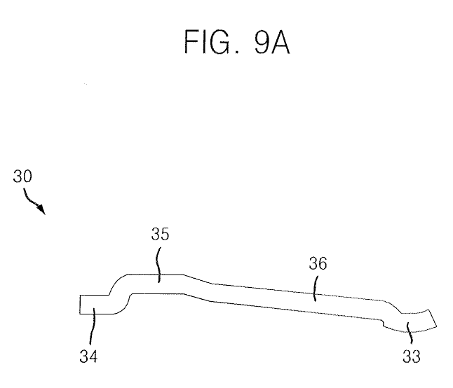

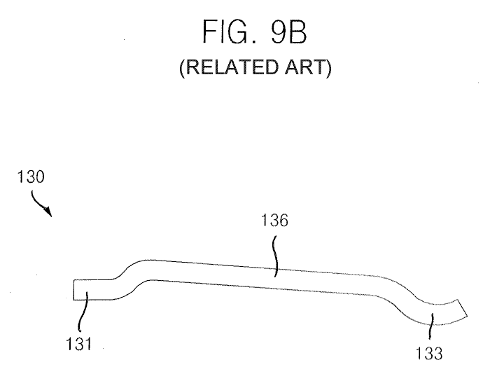

FIG. 9A is a cross-sectional view of the disk clamp taken along line VIII-VIII of FIG. 6. FIG. 9B is a cross-sectional view of the conventional disk clamp taken along line II-II of FIG. 1.

Referring to FIG. 9A, the disk clamp 30 according to an example embodiment of the present general inventive concept can further include a horizontal portion 35 extending a predetermined distance toward the pressing portion 33 and which maintains a predetermined height after being bent upwardly from the accommodation portion 34, and an inclined portion 36 to connect the horizontal portion 35 and the pressing portion 33 by being inclined downwardly with respect to the horizontal portion 35. A connection portion between the accommodation portion 34 and the horizontal portion 35 can be substantially bent by about 90°.

Accordingly, since the disk clamp 30 according to an example embodiment can include the horizontal portion 35 to maintain a predetermined height with respect to the accommodation portion 34, unlike the conventional disk clamp 130 (refer to FIGS. 1 and 9B) having only an inclined portion 136 between the accommodation portion 34 and the pressing portion 33, a decrease in the overall strength of the disk clamp 30 generated as the sectional thickness of the particular area 30A decreases may be compensated for and furthermore the overall clamping force may be increased. This is because the overall sectional length of the disk clamp 30 according to the example embodiment can be increased compared to the conventional disk clamp 130 having only the inclined portion 136.

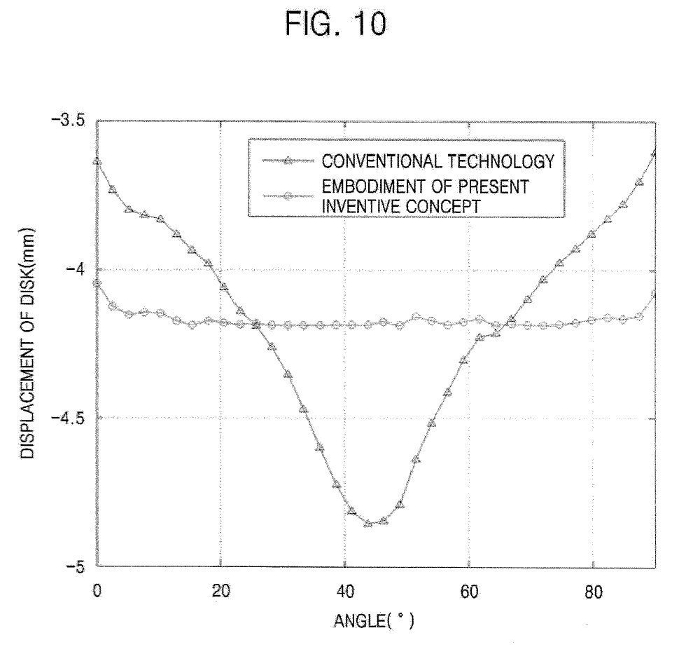

FIG. 10 is a graph illustrating a result of comparison in the circumferential disk displacement distribution generated between the conventional disk clamp 130 of FIG. 1 and the exemplary disk clamp 30 of FIG. 6. In the graph of FIG. 10, the vertical axis denotes the displacement of the disk 11 at the contact surface between the disk clamp 30 and the disk 11 while the horizontal axis denotes the position of the disk clamp 30 in the circumferential direction. The angle “45°” on the horizontal axis denotes a position where one of the four through holes 32 is formed while the angles “0°” and “90°” on the horizontal axis denote an intermediate position between neighboring two of the four through holes 32.

As illustrated in FIG. 10, the graph corresponding to a disk clamp 30 configured in accordance with the present general inventive concept indicates that the overall clamping force can be increased and the uniformity of the disk displacement distribution, or the stress distribution, can be remarkably improved compared to the conventional disk clamp 130 of FIG. 1.

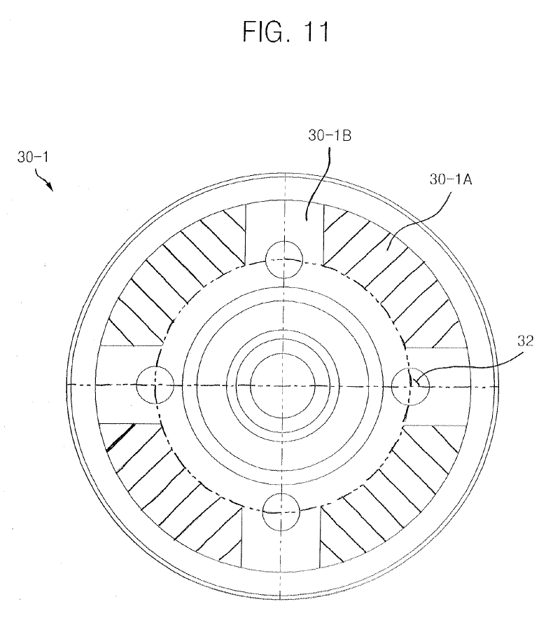

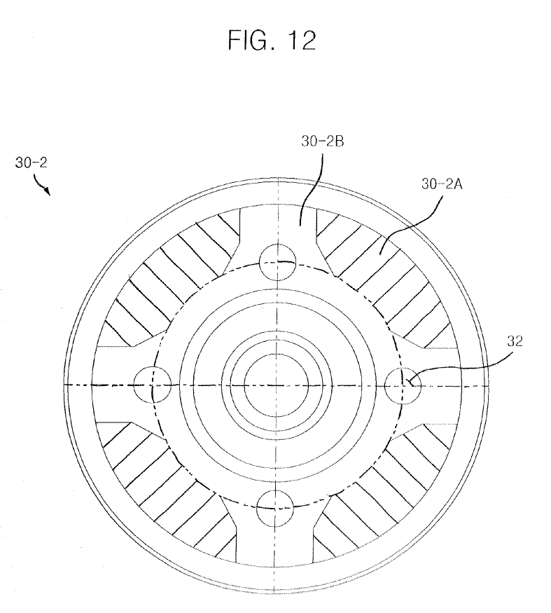

FIGS. 11 and 12 are plan views of a disk clamp according to other exemplary embodiments of the present inventive concept. Here, FIGS. 11 and 12 respectively illustrate disk clamps 30-1 and 30-2 having different shapes of particular areas 30A-1 and 30A-2 which may minimize the decrease in the overall strength and provide a uniform stress distribution at the contact surface between each of the disk clamps 30-1 and 30-2 and the disk 11.

For example, referring to FIG. 11, the place surface of a predetermined area 30B-1 that is adjacent to each of the through holes 32 can have a substantially rectangular shape. It is also possible that the place surface of a predetermined area 30B-2 that is adjacent to each of the fourth through holes 32 can have a combined shape of the triangular shape of FIG. 7 and the rectangular shape of FIG. 11, as illustrated in FIG. 12. Although it is not illustrated in the accompanying drawings, it is also possible that the place surface of the predetermined area 30B that is adjacent to each of the fourth through holes 32 may have a substantially oval shape.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A disk clamp to fix a disk to a hub of a spindle motor in a hard disk drive, the disk clamp comprising:
a coupling hole formed at a center of the disk clamp, in which a clamping screw is inserted;
at least one through hole formed outside the coupling hole; and
a pressing portion provided at an outer circumferential side of the disk clamp to contact and press the disk,
wherein a particular area around the at least one through hole that is disposed away from the at least one through hole has a sectional thickness thinner than a predetermined area that is adjacent to the at least one through hole, to prevent stress distribution generated at a contact surface between the pressing portion and the disk from being irregular due to the at least one through hole.

2. The disk clamp of claim 1, wherein the at least one through hole comprises a plurality of through holes formed outside the coupling hole in a circumferential direction, and the particular area is obtained by deducting the predetermined area that is adjacent to each of the plurality of through holes from a first zone that is an area between the pressing portion and an imaginary closed curve connecting the centers of the plurality of through holes.

3. The disk clamp of claim 2, wherein a second zone that is an area between the imaginary closed curve and the coupling hole has substantially the same sectional thickness as the predetermined area that is adjacent to each of the plurality of through holes.

4. The disk clamp of claim 1, wherein the particular area is stamping processed to have a sectional thickness thinner than the predetermined area that is adjacent to the through hole.

5. The disk clamp of claim 2, wherein the predetermined area that is adjacent to each of the plurality of through holes has a substantially triangular shape.

6. The disk clamp of claim 5, wherein the predetermined area that is adjacent to each of the plurality of through holes is defined by the imaginary closed curve and two straight lines forming a substantially triangular shape.

7. The disk clamp of claim 6, wherein the two straight lines are symmetrical to an imaginary line connecting the center of the coupling hole and the center of the through hole and are respectively inclined by an angle within a range of about 10°-20° with respect to the imaginary line.

8. The disk clamp of claim 2, wherein the predetermined area that is adjacent to each of the plurality of through holes has a substantially oval or polygonal shape.

9. The disk clamp of claim 1, wherein the particular area is processed to have a sectional thickness difference in a range of about 0.1 mm to about 0.15 mm, compared to the predetermined area that is adjacent to the through hole.

10. The disk clamp of claim 2, wherein the plurality of through holes are guide holes to align the disk clamp on the hub of the spindle motor, and are four through holes formed in the disk clamp in the same interval in the circumferential direction.

11. The disk clamp of claim 2, wherein the plurality of through holes are disposed on a single circle to allow the imaginary closed curve to form a circle.

12. The disk clamp of claim 1, further comprising:
an accommodation portion to support a head portion of the clamping screw; and
a horizontal portion to extend toward the pressing portion and to maintain a predetermined height after being bent upwardly from the accommodation portion.

13. The disk clamp of claim 12, further comprising an inclined portion to connect the horizontal portion and the pressing portion by being inclined downwardly with respect to the horizontal portion.

14. A hard disk drive comprising:
a disk on which data is recorded and reproduced;
a spindle motor to rotate the disk; and
a disk clamp to fix the disk to a hub of the spindle motor, the disk clamp comprising:
a coupling hole formed at a center of the disk clamp, in which a clamping screw is inserted;
at least one through hole formed outside the coupling hole; and
a pressing portion provided at an outer circumferential side of the disk clamp to contact and press the disk,
wherein a particular area around the at least one through hole that is disposed away from the at least one through hole has a sectional thickness thinner than a predetermined area that is adjacent to the at least one through hole to prevent stress distribution generated at a contact surface between the pressing portion and the disk from being irregular due to the at least one through hole.

15. The hard disk drive of claim 14, wherein the at least one through hole is a plurality of through holes formed outside the coupling hole in a circumferential direction, and the particular area is obtained by deducting the predetermined area that is adjacent to each of the plurality of through holes from a first zone that is an area between the pressing portion and an imaginary closed curve connecting the centers of the plurality of through holes.

16. The hard disk drive of claim 15, wherein a second zone that is an area between the imaginary closed curve and the coupling hole has substantially the same sectional thickness as the predetermined area that is adjacent to each of the plurality of through holes.

17. The hard disk drive of claim 14, wherein the particular area is stamping processed to have a sectional thickness thinner than the predetermined area that is adjacent to the through hole.

18. The hard disk drive of claim 15, wherein the predetermined area that is adjacent to each of the plurality of through holes has a substantially triangular shape.

19. The hard disk drive of claim 18, wherein the predetermined area that is adjacent to each of the plurality of through holes is defined by the imaginary closed curve and two straight lines forming a substantially triangular shape.

20. The hard disk drive of claim 19, wherein the two straight lines are symmetrical to an imaginary line connecting the center of the coupling hole and the center of the through hole and are respectively inclined by an angle within a range of about 10°-20° with respect to the imaginary line.

21. The hard disk drive of claim 14, further comprising:
an accommodation portion to support a head portion of the clamping screw; and
a horizontal portion to extend toward the pressing portion and to maintain a predetermined height after being bent upwardly from the accommodation portion.

22. The hard disk drive of claim 21, further comprising an inclined portion to connect the horizontal portion and the pressing portion by being inclined downwardly with respect to the horizontal portion.

23. A disk clamp to fasten a disk to a hub of a disk drive, the disk clamp comprising:
a coupling hole formed at a center of the disk clamp to receive the hub;
at least one through hole formed between an outer circumferential side of the disk clamp and the coupling hole; and
a pressing portion formed at the outer circumferential side of the disk clamp to contact a surface of the disk such that a thickness of a first sectional area of the disk clamp adjacent to the at least one through hole is greater than a thickness of a second sectional area of the disk clamp spaced apart from the at least one through hole.

24. A hard disk drive, comprising:
a disk clamp to fasten a disk to a hub of the hard disk drive, the disk clamp comprising:
a coupling hole formed at a center of the disk clamp to receive the hub;
at least one through hole formed between an outer circumferential side of the disk clamp and the coupling hole; and
a pressing portion formed at the outer circumferential side of the disk clamp to contact a surface of the disk such that a thickness of a first sectional area of the disk clamp adjacent to the at least one through hole is greater than a thickness of a second sectional area of the disk clamp spaced apart from the at least one through hole.
